(19) United States
(12) Patent Application Publication
(10) Pub. No.: US 2022/0358257 A1
(43) Pub. Date: Nov. 10, 2022

(54) MANAGING ITERATIONS AND BRANCHING IN DESIGN

(71) Applicant: Dassault Systemes Americas Corp., Waltham, MA (US)

(72) Inventors: Hsin-Chi Chang, Chelmsford, MA (US); Kevin Pollefoort, Bedford, MA (US); Boris Tabenkin, Georgetown, MA (US); William Upham, Nashua, NH (US)

(21) Appl. No.: 17/735,198

(22) Filed: May 3, 2022

Related U.S. Application Data
(60) Provisional application No. 63/183,736, filed on May 4, 2021.

(51) Int. Cl. G06F 30/12

(52) U.S. Cl. CPC G06F 30/12; G06F 2111/02

(57) ABSTRACT

In one aspect, a computer-based method is disclosed for managing iterations and branching in a design evolution. The method includes creating a module that corresponds to a component in response to a user command and storing at least a first iteration and a second iteration of a design for the component in the module. Each of the first and second iterations contains one or more content objects. Moreover, each content object is an entity (e.g., a businessobject) or a relation (e.g., a connector), is identified by a content identifier, and is part of a single unit of content that represents all evolutions of the entity or relation and is associated with a corresponding physical object.

### CROSS-REFERENCE TO RELATED APPLICATION(S)

This application claims the benefit of priority to U.S. Provisional Patent Application No. 63/183,736, entitled MANAGING ITERATIONS AND BRANCHING IN DESIGN, which was filed on May 4, 2021. The disclosure of the prior application is incorporated by reference herein in its entirety.

### FIELD OF THE INVENTION

This disclosure relates to the field of design (e.g., computer-facilitated product design) and, more particularly, relates to managing iterations and branching in design.

### BACKGROUND

A number of systems and programs are offered on the market for the design, the engineering and the manufacturing of objects. CAD is an acronym for Computer-Aided Design, which relates to software solutions for designing an object. CAE is an acronym for Computer-Aided Engineering, which relates to software solutions for simulating the physical behavior of a future product. CAM is an acronym for Computer-Aided Manufacturing, which relates to software solutions for defining manufacturing processes and operations. In such computer-aided design systems, users typically interact with and modify designs from user interface devices. Tracking and managing design iterations and branches in design evolutions utilizing these and other types of systems can be complex and inefficient. Improvements are needed.

### SUMMARY OF THE INVENTION

In one aspect, a computer-based method is disclosed for managing iterations and branching in a design evolution. The method includes creating a module that corresponds to a component in response to a user command and storing at least a first iteration and a subsequent iterations of a design for the component in the module. Each of the first and subsequent iterations contains one or more content objects. Moreover, each content object is an entity (e.g., a businessobject or a relation (e.g., a connection), is identified by a content identifier, and may be, for example, part of a single unit of content that represents all evolutions of a single businessobject or relation associated with a corresponding physical (e.g., real-world) object.

In another aspect, a computer-based system is disclosed for managing iterations and branching in a design evolution. The computer-based system includes one or more computer processing devices and computer-based memory operatively coupled to the one or more processing devices. The computer-based memory stores computer-readable instructions that, when executed by the one or more processors, cause the computer-based system to create a module that corresponds to a component in response to a user command and store at least a first iteration and a second iteration of a design for the component in the module. Each of the first and second iterations contains one or more content objects. Moreover, each content object is an entity (e.g., a businessobject) or a relation (e.g., a connection), is identified by a content identifier, and may be, for example, part of a single unit of content that represents all evolutions of a single businessobject or relation associated, for example, with a corresponding physical object.

In still another aspect, a non-transitory computer readable medium is disclosed. The non-transitory computer readable medium has stored thereon computer-readable instructions that, when executed by a computer-based processor, causes the computer-based processor to manage iterations and branching in a design evolution by creating a module that corresponds to a component in response to a user command and storing at least a first iteration and subsequent iterations of a design for the component in the module. Each of the first and subsequent iterations contains one or more content objects. Moreover, each content object is an entity (e.g., a businessobject) or a relation (e.g., a connection), is identified by a content identifier, and may be, for example, part of a single unit of content that represents all evolutions of a single businessobject or relation associated, for example, with a corresponding physical object.

In yet another aspect, an object-orientated data model includes a user-specified module containing content objects. Each content object is either a business object or a connection. Each content object has a content ID and an associated physical object. The content objects are organized into branches and iterations within the module. An iteration is a change to one or more contained content objects, and an associated one of the content IDs for one of the changed content objects refers to a different physical object after the change.

In some implementations, one or more of the following advantages are present.

For example, in various implementations, the systems and techniques disclosed herein provide for an efficient, relatively straightforward, and effective way of tracking, managing, and facilitating effective interactions with a design throughout various iterations and branching that may occur during a design evolution.

In some implementations, the systems and techniques disclosed herein may enhance the functionalities of a modeling engine of the 3DExperience Live Collaboration product of Dassault Systèmes. The invention adds the notion of object versioning including the notions of branching and iterating at the lowest level of the modeling engine. It is expected that the various and numerous applications that run on top of the modeling engine (kernel) may take advantage of the benefits of the invention.

Moreover, the treatment of the content object in a module, which includes both the entities (e.g., businessobjects) and the relationships is important. In some implementations, ContentID (e.g., a unique ID for a single unique object or relationship) can map to different underlying physical objects or relationships, without needing to be copied or cloned unless they are actually changed. Therefore, the contentID can identify the content over floating sets of branches and/or iterations.

Additionally, a typical implementation applies the notion of iterating and branching to the world of modeling, which always involves multiple, interrelated items. The modeling that Dassault Systèmes typically performs, for example, applies to modes of physical things (cars, airplanes, engines, etc.). In this world the individual items (i.e., parts) only makes sense in context of other objects (as part of an assembly). Implementations of the systems and techniques disclosed herein allow for and manage changes (iterations) and branches on whole models.

Some additional benefits of the systems and techniques disclosed herein include: 1) providing access to historical views of a model as it evolves over time, 2) parallel model evolution, and 3) space compactness.

Other features and advantages will be apparent from the description and drawings, and from the claims.

### BRIEF DESCRIPTION OF THE DRAWINGS

FIG. 1 is a schematic representation of an exemplary computer-based system that facilitates collaborative design processes for physical, real-world objects, typically with multiple subcomponents, typically by various users, according to the techniques disclosed herein that include tracking and managing of design iterations and branches in the design process within modules.

FIG. 2 is a schematic representation of an exemplary computer network environment that may be used to implement the functionalities disclosed herein including the tracking and managing of design iterations and branching.

FIG. 3 is a schematic representation showing a more detailed implementation of the system and/or network environment represented in FIGS. 1 and 2.

FIG. 4 is a flowchart showing an exemplary set of users' interactions with the system disclosed herein in designing an axle assembly.

FIGS. 5A-5H are schematic representations of various steps in the axle assembly design evolution represented in the flowchart of FIG. 4.

FIG. 6 is a schematic representation of an exemplary skateboard product structure that can be managed (e.g., by the system disclosed herein) in three modules: SkateBoard, AxleAssembly, and Brake.

FIG. 7 is a schematic representation showing an evolution of the modules in FIG. 6 as content is added and modified.

FIG. 8 is a view showing product iterations of a skateboard.

Like reference characters refer to like elements.

### DETAILED DESCRIPTION

This document uses a variety of terminology to describe its inventive concepts. Unless otherwise indicated, the following terminology, and variations thereof, should be understood as having meanings that are consistent with what follows.

For example, unless otherwise indicated, the phrase “content” refers to any and all evolutions of objects (e.g., entities, such as business objects, or relations, such as connections) in design processes. Content, in this regard, can be thought of as logical units that represents objects/entities (e.g., a businessobject and relations or connections) at any and all points in times during a design evolution. In an exemplary implementation, a connection is an instance of a relationship, and a businessobject is an instance of a type. Each piece of content may be represented in the system by ContentID (CID) which, in a typical implementation, is a universally unique identifier (UUID), and is thus unique. Each “content object” (e.g., entity, such as businessobject or relation, such as connection) will have a contentID that will be utilized to identify the content over a floating set of branches and iterations. Each content entry (e.g., in the system's database) typically identifies a contentID and its associated physical ID. The same physical ID can represent content in different branches or different iterations as long as the underlying content object is the same in both places. In a typical implementation, the physicalID associated with content is read-only and can only be deleted if all the branches referencing the content has been deleted.

Unless otherwise indicated, a “content object” is an instance of a data structure that represents content relating to particular content.

Unless otherwise indicated, “immutable” refers to the state of being represented by data in computer-based memory, where the data is unchangeable (i.e., not capable of being changed by a human user accessing the data or the immutable thing from a computer). Conversely, “mutable” refers to the state of being represented by data in the computer-based memory, where the data is changeable (i.e., capable of being changed, e.g., added to, deleted from, etc., by a user accessing the data or the mutable thing from the computer).

Unless otherwise indicated, the phrase “contentID” or “content identifier” refers to a unique identifier that represents a particular type of content (e.g., an axle assembly) at any and all points of time in a design process that may include iterations or branches. In a typical implementation, contentID is a universally unique identifier (UUID) that uniquely specifies every instance of content (e.g., a business object or connection/relationship) within a particular module. In a typical implementation, contentID can be associated to multiple physicalIDs as it goes through iterations. The objects identified by their physicalIDs are always read only. s may reference the same physicalID across multiple branches.

Unless otherwise indicated, the phrase “physicalID” or “physical identifier” refers to a unique identifier that identifies a single instance of an object (e.g., a business object or relationship) in a design process that may include iterations or branches.

Unless otherwise indicated, the phrase “module” refers to a virtual (computer-based) container that contains all versions of a particular object (e.g., business objects, such as an axle assembly, and/or connections) created in a design process that may include one or more iterations and/or branches. In a typical implementation, a module may be considered a virtual container of content (that corresponds to a portion of computer-based memory). The content is managed across branches and iterations within a module. Each branch within a module generally will have iterations representing a linear progression of content. Moreover, contentIDs are managed across the branches and iterations within a module so that the physical objects underlying the contentIDs will not need to be copied/cloned unless they are actually changed. Branches generally constitute a virtual tree, in which multiple branches may exist, each branch extending from, and connected to, its root/parent. A single content (e.g., an axle assembly) generally only belongs to one module. The initial branch in a particular module generally contains no content in its first iteration (iteration zero). Modules generally have user specified names, which may represent the object associated with the module's content (e.g., “axle assembly”).

Unless otherwise indicated, the phrase “branch” refers to a sequence of one or more linear progression of iterations to content in a module, including any one of a plurality of independent, parallel modifications to content in a module. Branching can be considered an organizational mechanism within a module. All branches, except the initial branch, have a parent branch and at least one iteration. The initial iteration of a new child branch duplicates bookkeeping data (e.g., any associations between the contentIDs and multiple physicalIDs as content is iterated) of its parent branch and iteration, but do not copy the physical objects themselves. Each branch generally has its own reference to its contentIDs and manages the association of each contentID to its underlying physicalIDs, as the content is changed. Iterations of a branch generally persist a set of add, delete or modification of content which will change the association between contentID and underlying physical object. In a typical implementation, each branch is associated with an owning module (i.e., a module that includes that branch). The initial branch in a module generally has no parent branch and its initial iteration is content free. All other branches in the module will derive (or extend, either directly or indirectly) from the initial branch and iteration therein (called a branch point). Moreover, each branch will generally have the same contentIDs as its parent but may contain its own content with subsequent iterations. A child branch is generally entirely independent from its parent branch. Changes to content in either the parent or the child branch will not affect the state of the other branch. In general, a merge operation is utilized to propagate changes from one branch to another. Iterations capture incremental changes to a branch's content. Each branch has a names that is unique at least within its module. Branches and their iterations are read only and their content cannot be directly modified.

Unless otherwise indicated, the phrase “iteration” refers to any change to content in a module. Some examples include a change in some attribute. An iteration typically results a new, unique, and immutable version of the content of the module's branch Subsequently, the contentID for that content will refer to the new physicalID that represents the changed version of content as well as the physicalID for any previous versions of that content. Iterations are generally linearly ordered instances of an object on a single branch within a module. An iteration is generally created only when the underlying object is effectively changed and saved (“copy on write”). In a typical implementation, it is possible to iterate business objects and/or connections. In general, iterating a business object will not result in an iteration of any associated connections, and iterating a connection will not result in an iteration of associated connections. In a typical implementation a connection connects 1 obj to 1 obj and both ends must exist. The ability to avoid iterating some content because of changes to associated content may save system resources and reduced complexity, as the underlying physical objects and all their data in those instances need not be cloned. Iterations are generally added to a branch (e.g., the initial branch or any subsequent branches) when a user commits content changes through a sandbox (e.g., a virtual workspace).

Unless otherwise indicated, an “entity” is a representation, in a computer environment (e.g., in computer-based memory), of a basic unit of data representing parts of the model. It holds some basic information like a type, an owner, a creation date, a modification date, etc. and optionally some custom attributes such as color, size, etc. One example of an “entity” is a BusinessObject.” A “BusinessObject” can be connected to other BusinessObjects through connections.

Unless otherwise indicated, a “relation” is a representation, in a computer environment (e.g., in computer-based memory). One example of a “relation” is a “connection.” A connection is a kind of entity that is used to connect businessobjects. Connections are similar to businessobjects except they hold a from and a to reference to other entities. Moreover. a relation and a connection are highly similar and may, in some instances, be used interchangeably. That said, the term “relation” usually means the definition of the model of relationship when connection is a particular instance of relation.

Unless otherwise indicated, the phrase “sandbox” refers to a virtual staging area or workspace, in which a user can modify (e.g., add to, or delete from) an object and then commit the modified object, as a new immutable iteration, to its parent branch in a module. In a typical implementation, a Sandbox is a macro-container created by a user in which adds/modifies/deletes of content can be performed on a mutable copy of data. When the changes are deemed ready, they can be committed to the parent branch, creating a new iteration in the parent branch. The commit operation will make the data available to the world in an immutable state. A sandbox may be defined by attaching one or more modules and/or branches to identify content to be worked on in the sandbox. A user can generally modify his sandbox to change the attached modules/branches at any time. A sandbox can attach more than one branch of a single module, although content changes may need to specify the branch if it is ambiguous. In general, a sandbox can be synchronized with a parent branch if another concurrent sandbox committed changes creating a new iteration on that branch. The sandbox generally synchronizes with the new iteration of the parent and if conflicts or changed content are detected any conflicts must generally be resolved. All iterations of a branch, other than the initial iteration, are created by committing new, modified content from the Sandbox. A sandbox can generally only be committed if its parent branch's latest iteration is the basis for the sandbox. Sandboxes are generally associated with a single user, and only that user can change content within that sandbox. In addition, the sandbox name generally provides a unique namespace for each user. The duplication of the object to be modified generally happens only when the first change happens (copy on write).

Unless otherwise indicated, the phrase “filter” refers to a virtual tool that enables a user to filter through database entries and specify object versions by module, branch and/or iteration. Filters enable specification of module/branch/iteration to allow users to find and read different views of a data model at different times in history. In general, a new keyword “profile” will be available when setting context. To set filters during a query or expand, a “set context” command may be used as:
set context Dave profile SkateBoard/V6/1,AxleAssembly/V6/1,Brake/V6/1;
   A user can also set context to a particular sandbox and in addition apply profile settings.

set context user Dave sandbox s1 profile Module1/Branch1,Module2/Branch2;

Note that in the first profile above, the iteration (1) was specified on each branch, so it will fetch the physical objects that correspond to the content objects in that single iteration. The second profile specifies just the branch for Module2, so it will fetch the physical objects corresponding to the content objects in the last iteration of Branch2. If profile needs to be changed, then the “set context” command may need to be used again. If an object is part of multiple profiles, then it could be returned more than once. If iteration is not used in the profile, then, in a typical implementation, the latest iteration will be used. A user can also generally use the sandbox option to set context to a particular sandbox and in addition apply filters.

Unless otherwise indicated, the phrase “filterset” refers to a virtual tool that includes a set of filters that enables a user, for example, to filter through database entries and specify an object version by module, branch, and iteration.

Unless otherwise indicated, the phrase “URL” refers to a uniform resource locator adapted for use with the systems and techniques disclosed herein. Generally speaking, a URL is a reference to a resource that specifies its location on a computer or computer network and a mechanism for retrieving it. In a typical implementation, the systems and techniques disclosed herein involve addressing content in a more complex way than what has been done previously. In this regard, the notion of a single object being addressable with a single PhyisicalID (PID) does not work. The benefit of using a URL is that allows a single file to specify multiple pieces of information. Given that in the system and techniques disclosed herein content is expressed in terms of modules and branches and iterations, the URL provides a compact form. In the spirit of the modern internet trends, the following table defines various URL that may be used to address and/or filter content within the context of the systems and techniques disclosed herein.

Content URL:

The content URL is defined as follows: cid://uuid{branch {iteration}}

| Example | Description |
|---|---|
| cid://uuid | Signifies all versions of the content. This form will |
| | return the appropriate instance based on the profile |
| | and/or sandbox filtering. |
| cid://uuid/branch | Specifies the latest iteration of the content |
| | on the given branch. |
| cid://uuid/branch/iteration | Specifies the particular instance of the content |
| | (e.g., in iteration 5). |
| Selectable | The selectable will return the URL. |

Filter URL:

The purpose of the filter URL is to specify the filter for the session. The FilterSet will contain the list of filters. The system will evaluate the filter by matching on the module and applying the branch filtering accordingly.

The filter URL is defined as follows: filter://module/{branch {iter}}

| Example | Description | Example |
|---|---|---|
| filter://module | Specifies the module | filter://m1 |
| | using the root branch. | |
| filter://module/branch | Specifies the module and | filter://m1/b1 |
| | branch. | |
| filter: //module/branch/iter | Specifies a specific | filter://m1/b1/100 |
| | instance of the object. | |

“Design evolution” refers to the process by which a design (e.g., of a product and/or component of a product), as represented in a computer-based environment, changes or develops over time.

Product design generally requires coordinating the efforts of various contributors working in parallel and sometimes simultaneously on various interrelated parts of the product being designed. The contributors may be from different groups within the same company or may even be from different companies. This coordination can be complex especially when the product being designed has many parts and those parts interrelate and depend on one another. Tracking and managing design changes effectively in this sort of environment can be challenging. The systems and techniques disclosed herein provide for tracking and managing such design changes, including design iterations, branching, etc. In a typical implementation, these systems and techniques help promote efficiency, reduce cost, avoid, or minimize design conflicts, and facilitate success in the overall design process.

### Prior Change-Tracking Technologies

Some prior technologies exist for tracking changes in various items. The systems and techniques disclosed in present application differ from those prior technologies in approach, context, etc. For example, the systems and techniques disclosed in the present application involve tracking and managing multiple interrelated modules within the context of an overall assembly of the modules, where each respective module may experience multiple independent iterations and/or branches in its own design evolution. None of the prior optimization techniques discussed below involves tracking and managing multiple interrelated modules within the context of an overall assembly of the modules, where each respective module may experience multiple independent iterations and/or branches in its design evolution, as disclosed in the present application. Moreover, none utilize a data model to facilitate such tracking and modeling in much the same ways as disclosed herein.

### Source Code Management (SCM)

Source code management (SCM) systems have been used for years to track software modifications (e.g., in source code repositories) for the software development industry. Essentially, SCM systems are version control systems that track changes to software files to help coordinate work among software programmers cooperating on source code development programs, SCM systems typically maintain a running history of changes to a code base and help resolve conflicts when merging updates from multiple contributors.

In a typical SCM system, when content changes are committed to the repository, the file is iterated. SCM versioning generally allows previous versions to be made available for examination and also allows files to be restored to some previous state. Some SCM systems allow for branching too. Branching refers to the notion that software development is not always done in serial manner. Rather, sometimes, the need arises to branch off into parallel development paths. The nature of parallel development is such that sometimes the product has truly divergent paths (e.g., if there are going to be various releases and/or specializations), while other times the parallelization is of temporary nature (e.g., related to bug fixing or the like). Many times, there may be a need to later combine any such parallel paths, referred to as branch merging, after branching.

There are numerous examples of SCM systems. One of the more well-known examples of an SCM system is GIT, a free, open source SCM system.

The systems and techniques disclosed herein are similar in some ways to SCM in that they provide functionalities relating to tracking and managing iterations and branching. However, the systems and techniques disclosed herein apply to a very different kind of environment than SCM and differ from SCM in very significant ways.

More specifically, for example, the systems and techniques disclosed herein relate to modeling in the context of product design; they do not relate to software development like SCM does.

Moreover, unlike SCM, which generally only deal with individual items (e.g., single software files) at any particular time, the world of three-dimensional (3D) design or modeling almost never deals with a single item. 3D design or modeling typically relates to designs for a of a physical products (e.g., a car, an airplane, an engine, a skateboard, etc.) that include several subcomponents (e.g., the individual parts). The design evolution for each individual subcomponent can include multiple iterations and/or branches separately from the other individual subcomponents and separately from the overall assembly. Ultimately, as long as every iteration on every branch for a particular subcomponent design meets the applicable requirements for integrating into the overall assembly, the iterations and/or branches for a particular subcomponent may be considered interchangeable and suitable for inclusion in the assembly. Implementations of the systems and techniques disclosed herein facilitate managing any such iterations and/or branches of individual subcomponents within the context of designing the overall assembly.

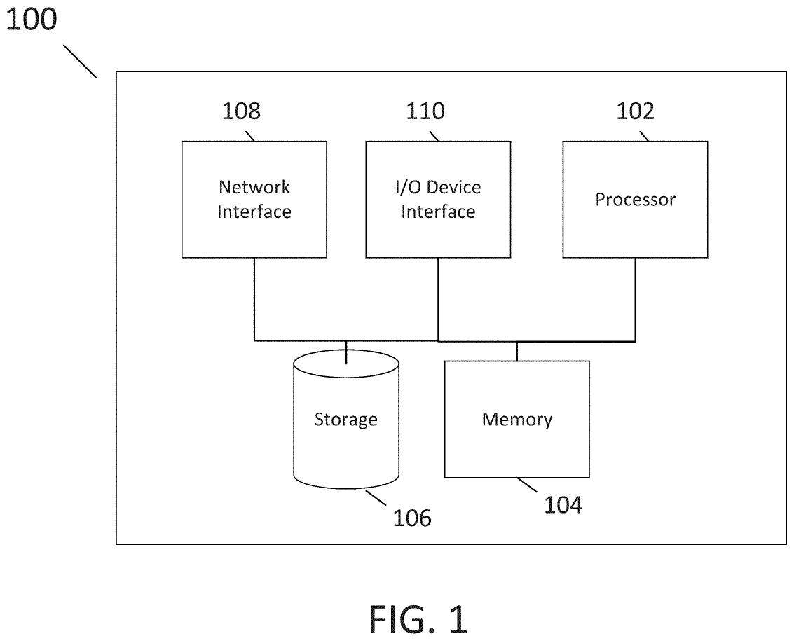

FIG. 1 is a schematic representation of an exemplary computer-based system 100 that facilitates collaborative design processes for physical, real-world objects, typically with multiple subcomponents, typically by various users, according to the techniques disclosed herein that include tracking and managing of design iterations and branches in the design process within modules.

More specifically, in a typical implementation, the system 100 is configured to store each design iteration within an object-oriented data model that includes various user-created modules, each of which corresponds to a particular one of the subcomponents, and each of which stores every committed iteration of the subcomponent design in every branch that subcomponent experienced in its design evolution. Each committed iteration in a particular module includes one or more content objects (e.g., business object or connection between business objects). Each content object has a content ID (e.g., a universally unique identifier for that content) and is associated with a corresponding physical object or subcomponent (e.g., an axle assembly). The content objects are organized within a module into branches and iterations. An iteration is a change to one or more of the content objects that causes the associated content IDs to refer to one or more different physical objects.

The system 100 stores each committed iteration (including its content objects) within a module and a branch in an immutable form that is generally accessible to every authorized user of the system 100. In a typical implementation, the system 100 enables each authorized user to access any iteration in any module by specifying, in a query or the like, the module, branch and/or iteration identifier for the desired iteration, and also enables each authorized user to access any combination of iterations from different modules (e.g., from a board module, an axle assembly module, and a braking mechanism mechanism) together. When a user makes such a request, the system 100 is configured to provide a copy of the identified iteration, in a mutable form, in a virtual workspace (e.g., sandbox) that is specific to that user. In a typical implementation, each authorized system user might have his or her own sandbox. The system 100 enables the user to then modify the mutable form of the iteration provided in his or her sandbox by changing existing content, adding new content, and/or deleting existing content. In a typical implementation, for as long as the mutable version of the identified iteration, including any modifications that the user may make to that iteration in his or her sandbox, remains in the user's sandbox, it is accessible only from that specific user's sandbox—and not to any other system users. Once the user saves (or commits) his or her changes, the system 100 saves the modified version in the module, as a new iteration (and/or branch, as designated) and that new iteration then becomes accessible to all other system users.

The computer-based system 100 has a processor 102 (e.g., a CPU), computer-based memory 104, computer-based storage 106, a network interface 108, an input/output device interface 110, and a bus that serves as an interconnect between those components. In a typical implementation, the bus provides a communications medium over which the various components of the computer-based system 100 can communicate and interact with one another.

The central processing unit (CPU) 102 is configured to perform various computer-based functionalities, including those disclosed herein. Typically, the CPU performs these functions by executing computer-readable instructions from a non-transient computer-readable medium, such as computer-based memory 104 and/or computer-based storage 106, and/or from computer-readable data received from an external source via the I/O device interface 110 and/or the network interface 108, for example.

The computer-based memory 104 provides a form of volatile storage for computer-readable instructions that, when executed by the CPU 102, cause the CPU to perform various computer-based functionalities including, for example, those disclosed herein.

Computer-based storage 106 provides a form of non-volatile storage for software instructions, such as an operating system (not shown), and embodiment configurations, etc.

The network interface 108 is for connecting to any variety of computer-based or communications networks, including, for example, local area networks (LANs), and/or wide area networks (WANs) such as the Internet.

The input/output device interface 110 is configured to act as a connection interface for one or more input and/or output devices such as a keyboard, mouse, display, speakers, etc. In a typical implementation, the computer system 100 may configured so as to display (e.g., on a display device connected to the I/O device interface 110) a visual representation of an interface to a collaborative product design environment, such as the one provided by and within the 3DExperience® platform, available from Dassault Systèmes America Corp., the applicant on this patent document. Also, in a typical implementation, the computer system 100 may be able to display (e.g., on a display device coupled to the I/O device interface 110) a visual representation of data relevant to the functionalities associated with the tracking and managing of design iterations and/or branches for subcomponents of an overall assembly design.

In various implementations, the computer system 100 may have additional elements, such as controllers, buffers (caches), drivers, repeaters, and receivers, to facilitate communication and other computer-based functionalities. Further, the interfaces may include address, control, and/or data connections to facilitate communication among the illustrated components.

In various implementations, the components of the system 100 represented in the illustrated schematic diagram may be contained in one or more physical devices. For example, the processor 102 may represent a single processor in a single physical device (e.g., a laptop or desktop computer, or a server) or may represent a plurality of processors distributed across multiple physical devices (e.g., one or more laptop computers and one or more network servers) working collectively to provide the functionalities disclosed herein. As another example, the memory 104 and/or the storage 106 may be contained within a single physical device (e.g., a laptop or desktop computer or a server), or may be distributed across multiple physical devices connected together via a network. In network configurations where the components of the system are distributed across multiple physical devices connected via the network, each discrete may include a network interface 108, an I/O device interface 110 and/or any one or more of a variety of other possible computer system components.

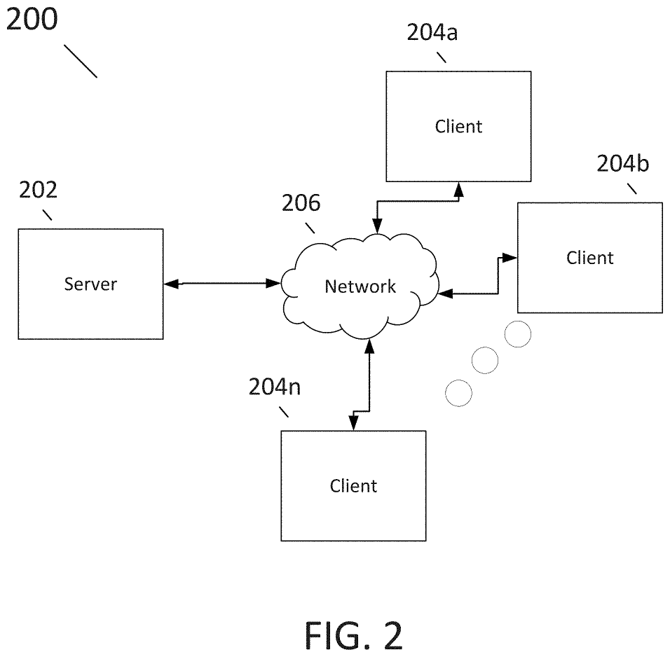

FIG. 2 is a schematic representation of an exemplary computer network environment 200 that may be used to implement the functionalities disclosed herein including the tracking and managing of design iterations and branching.

The illustrated computer network environment 200 has a server 202, and clients 204a, 204b, . . . 204n coupled to one another via a communications network 206 that enables the server 202 and clients 204a to communicate and interact with one another. In some implementations, one or more (or every single one) of the clients 204a, 204b, . . . 204n, and the server 202 may have the same types of components as those shown in the computer system 100 of FIG. 1. In some implementations, each client 204a, 204b, . . . 204n may be configured to perform at least some of the functionalities associated with tracking and managing design iterations and branching disclosed herein without requiring involvement of the server 202. In some implementations, the functionalities disclosed herein associated with tracking and managing design iterations and branching may be distributed between the server 202 and the clients 204a, 204b . . . 204n. In some implementations, a significant portion (or all) of the functionalities disclosed herein associated with tracking and managing design iterations and branching are performed by the server 202.

Various implementations may include one or more servers 202. In implementations that include more than one servers, the servers 202 typically collaborate with each other and/or one or more of the clients 204a, 204b . . . 204n to provide or perform the functionalities disclosed herein associated with the tracking and management of iterations and branching in product design processes.

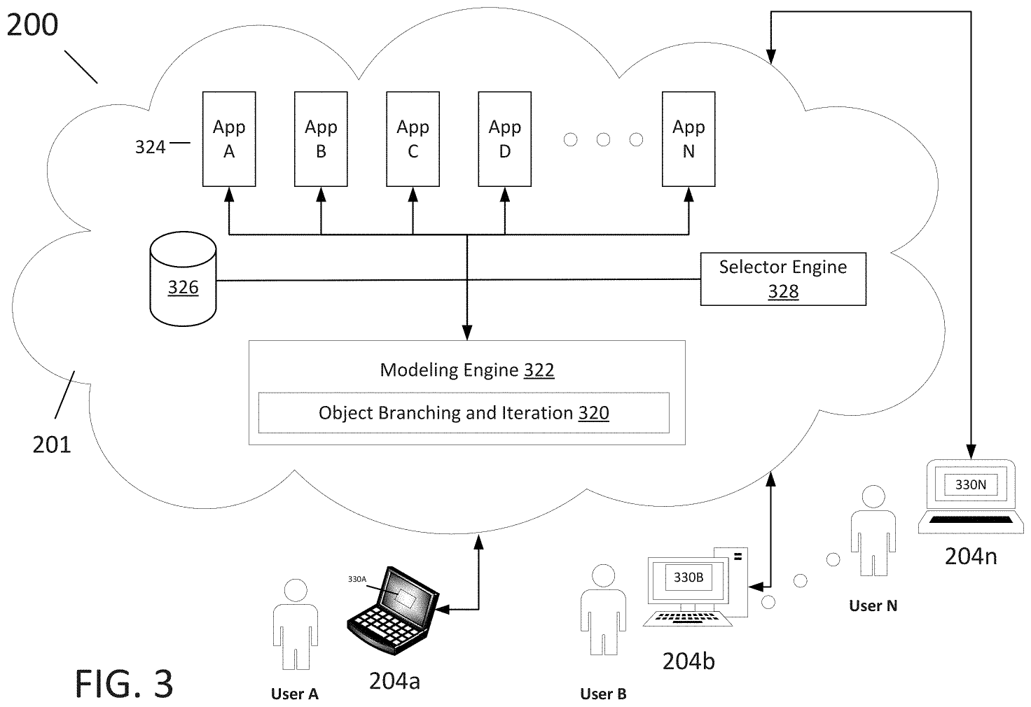

FIG. 3 is a schematic representation showing a detailed implementation of the network environment 200 represented in FIGS. 1 and 2.

The network environment 200 shown in FIG. 3 has a cloud-based collaborative product design and development platform 201 that can be accessed and utilized by a plurality of users (User A, User B . . . User N) from a plurality user workstations 204a. 204b . . . 204n to collaborate, for example, on the design of a real-world product or assembly (e.g., an automobile, an airplane, a skateboard, etc.). The assembly being designed may include numerous subcomponents. For example, if the assembly is an axle assembly for a skateboard, then the subcomponents of the assembly may include an axle, wheels, and a brake assembly.

The platform 201 in the illustrated implementation has a modeling engine 322, a plurality of software applications (App A, App B, App C, App D . . . App N) 324, a database 326, a query/filter/selector engine (also referred to as simply “selector 328” or “selector engine 328”), and virtual workspaces (referred to as “sandboxes 330a, 330b . . . 330n”) deployed on each user interface terminal.

The modeling engine 322, in a typical implementation, may be implemented via modeling software (e.g., a geometrical modeling kernel) being executed by a processor to provide users (e.g., User A, User B . . . User N) at user interface terminals with access to various 3D modeling functionalities. The modeling engine 322 can utilize and/or be based on any one of a variety of different software-based modeling engines. Some examples are CATIA® modeling software and Solidworks® software. Another example is the 3D ACIS modeler, which is a geometrical modeling kernel developed by Spatial Corporation, which is part of Dassault Systèmes. The ACIS modeler, for example, typically provides 3D modeling functionalities, 3D model management functionalities, and 3D model visualization functionalities. In some implementations, the ACIS modeler may have one or more ACIS modeler extensions that include, for example, a CGM polyhedral extension, a 3D deformable modeling extension, an advanced covering extension, a defeaturing extension, and/or a CGM hidden line removal extension. Another example of the software-based modeling engine is the Parasolid® geometric modeling kernel from Siemens PLM Software.

The software applications 324, in a typical implementation, may be any one or more of virtually any kind of software application that interacts with and/or leverages functionalities of the modeling engine 322. Examples include software applications for computer-aided design (CAD), computer-aided manufacturing (CAM), computer-aided engineering, product visualization, etc. One specific example of a software application that may interact with and leverage functionalities associated with the modeling engine 322 is the ENOVIA® product lifecycle management (PLM) software application from Dassault Systèmes. The ENOVIA® application is a standards-based, scalable PLM system that can generally support end-to-end product development processes for all companies, from small and mid-sized businesses (SMBs) to large, global enterprises. In a typical implementation, one of more of the applications 132 provide the users (User A, User B . . . User N) at user interface terminals with the ability to collaboratively design and develop one or more products from computers 204a, 204b . . . 204n. The designing involved therein can include one or more (or all) of the users creating iterations of a design and/or branching the design process in more than one direction. In a typical implementation, applications operate on content by referencing at least the content's contentIDs. Typically, the kernel will manage the association between the contentID and the underlying physical objects in order to deliver the correct physical object depending on a context and filtering specifications. In general, when the last content reference to a physicalID is removed, the physical object may also be removed by the kernel.

The database 326, in a typical implementation, may be or include any one of a variety of computer-based database platforms. In general terms, a database is an organized collection of data (in this case, the data would be related to product design and development) stored electronically (e.g., in 104 or 106 of FIG. 1) and accessible from a computer (e.g., 204a, 204b . . . 204n) typically through a database management system. In a typical implementation, the data stored in the database 326 is immutable and accessible (but not changeable) by all authorized users of the system (e.g., from any of the user interface devices 204a, 204b . . . 204n). The stored data in this regard typically includes, for every design represented in the database, a single version of every iteration of that design that was published (and, thereby, made immutable) to the database 326, along however many branches for that design are represented by the stored data. One specific example of database 326 is the Microsoft SQL Server, which a relational database system that stores and that is able to retrieve data as requested (e.g., by users or by other software applications (e.g., 324)) and that includes a relational database management system, developed by Microsoft Corporation. Other database platforms are possible. In a typical implementation, the stored data relates to product designs being developed by users (User A, User B . . . User N), alone or, more likely, collaboratively, using any of the indicated applications 324. This includes, of course, the data mentioned above regarding any product design iterations and/or branches in the design processes.

The selector engine 328 can be virtually any kind of computer-based engine (implemented via software being executed by one or more processors) that returns data from the database in response to a selection made by an authorized user (e.g., from any one of the user interface devices). For example, if a user at a particular one of the user interface terminals wished to view a particular iteration of a particular design on a particular branch, the user can enter a request to the selection engine from the user interface terminal to return (from database 326) the desired design, iteration, and branch to his local user interface terminal. In a typical implementation, the selector engine 328 sits atop the database 326 and executes queries against data in that database, based on user requests, to provide answers to users or applications. More specifically, in some implementations, a SQL query engine, for example, may interpret user requests as SQL commands and language to access data stored in a relational database system. A few examples of such query engines may include Presto, Apache Drill, Cloudera Impala, and Apache Spark.

The sandboxes 330a, 330b . . . 330n are virtual workspaces that are deployed on the user interface devices In a typical implementation, each sandbox appears as a field on the screen of its associated user interface devices 204a, 204b . . . 204n and is able to display design(s) for users to view and/or modify as desired. In a typical implementation, if/when a user (at one of the user interface devices) requests to access a particular design/branch/iteration of an object (or combination of designs/branches/iterations) saved in the database 326, the selector engine 328 returns a copy of the requested design/branch/iteration of the object to appear in the sandbox. The copy of the requested object that appears in the sandbox is mutable. In other words, the user is able to modify the copy of the request object that appears in the sandbox. In some implementations, the user may utilize one or more of the system's applications to make any such modifications. Once the user has made any desired changes to the copy of the object that appears in the sandbox, that user can publish (or save) the modified object back to the database 326. When this happens, the originally requested design/branch/iteration version of the object (which is and has been immutable) remains as it originally was in the database 326, and a new version, with a new design/branch/iteration designation, of that object is added to the database 326. The new version includes the modifications that the user made in the sandbox. Once the new version of the object is added to the database 326, that new version ns no longer mutable.

The platform 201 also has an object branching and iteration component 320 that, in the illustrated implementation, is represented as an enhancement to, and is embedded within, the modeling engine 322. The object branching and iteration component 320 manages overall object branching and iteration functionalities disclosed herein. Typically, the object branching and iteration component 320 may be implemented as software being executed by one or more processors. The object branching and iteration component 320, in the illustrated implementation, is represented as an enhancement to the modeling engine 322 at the lowest level of the modeling engine 322. The object branching and iteration component 320 is configured to perform functionalities associated with tracking and/or managing iterations and branches in design processes conducted on platform 201. In a typical implementation, this includes creating and maintaining/updating object-oriented data models for designs created, iterated, and branched on the platform 201.

The various components of the collaborative product design platform 201 and other portions of the system 200 are coupled to one another in a manner that enables them to interact with one another to provide the object branching and iteration functionalities disclosed herein. In various implementations, any one or more of those component may be implemented by a computer-based processor (e.g., 102 in server 202) executing functionalities pursuant to computer-readable instructions stored on a computer-readable storage medium (e.g., 104/106 in server 202).

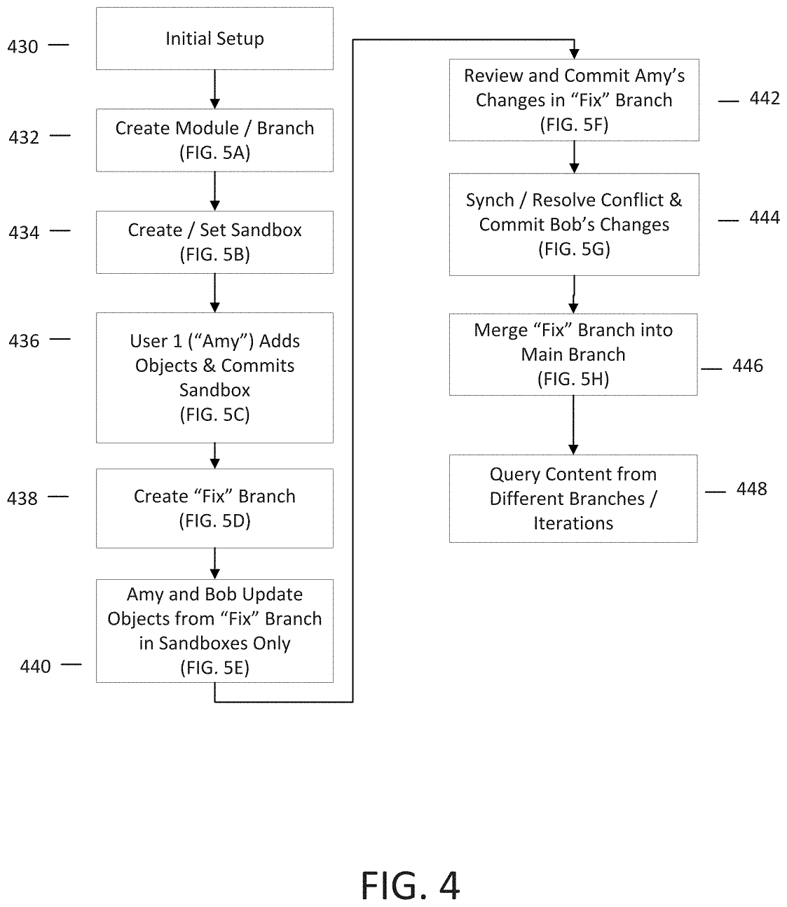

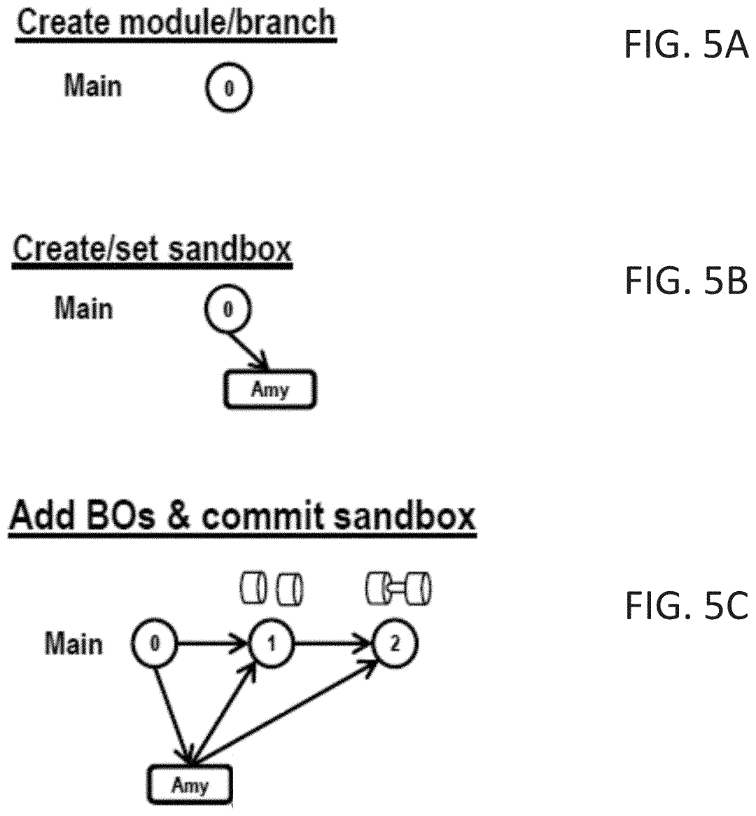

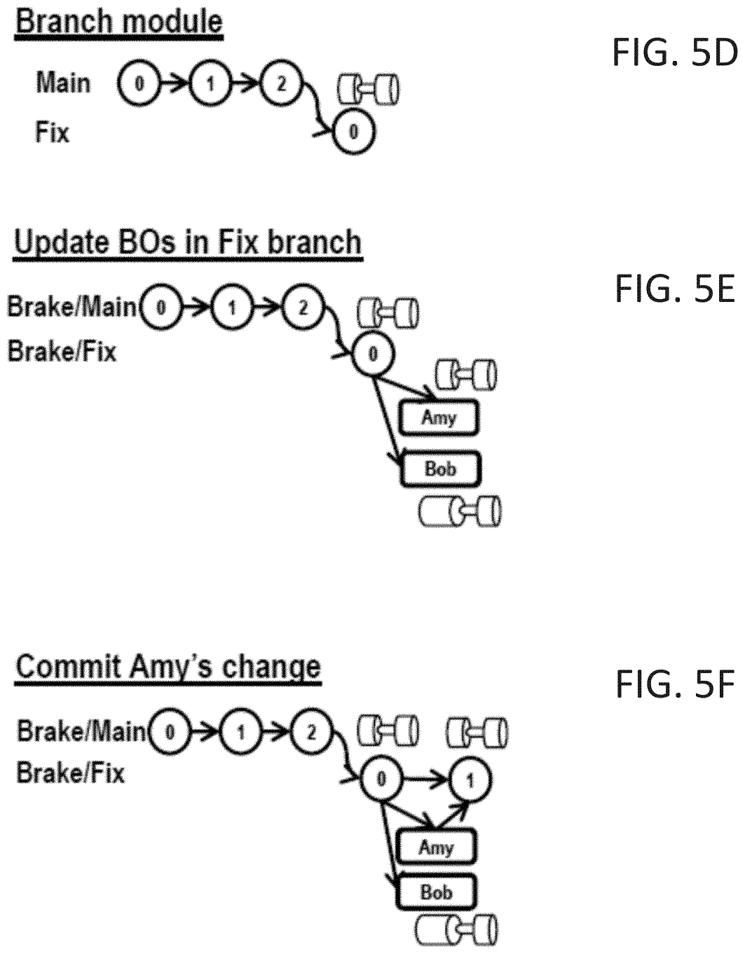

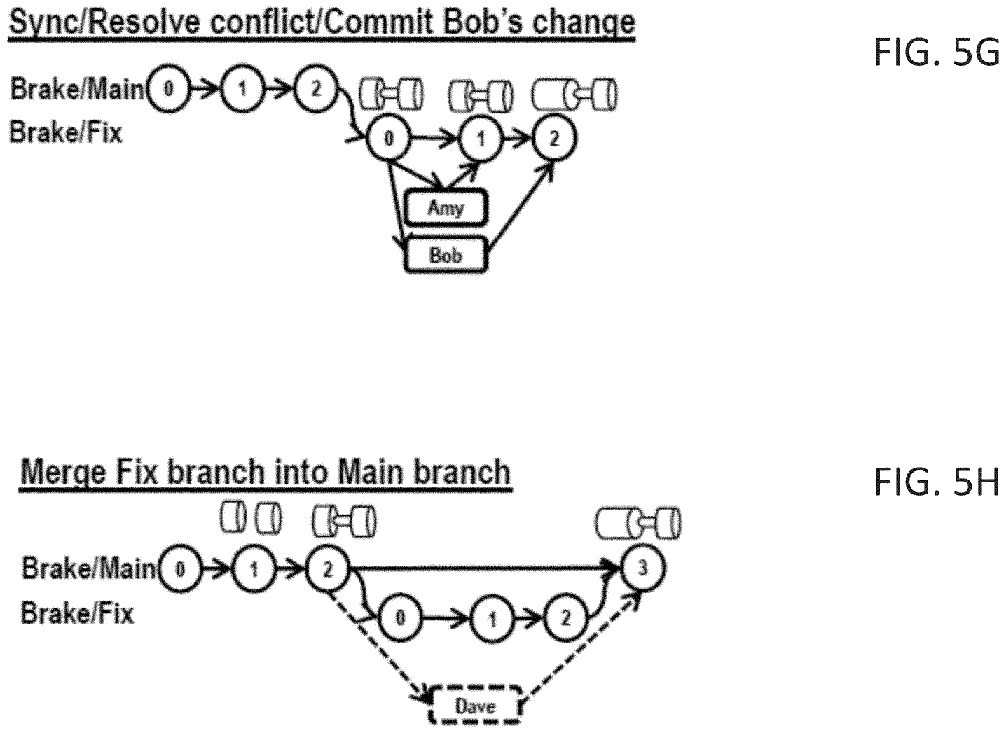

FIG. 4 is a flowchart showing an exemplary set of users' interactions with the system disclosed herein in designing an axle assembly. FIGS. 5A-5H are schematic representations of various steps in the axle assembly design evolution represented in FIG. 4. Also provided below are pseudocode representations of commands that may be invoked by the system (e.g., in response to inputs from a user at one of the user interface devices) at the various steps in the flowchart of FIG. 4. In a typical implementation, these (and other) commands may be implemented as commands in an MQL Scripting language.

The first step in the flowchart of FIG. 4 is a setup step 430. In some implementations, setup 430 may involve the system executing functionalities based on the following:

add vault unit1;
add attribute color type string default “green”;
add type VPLMReference attribute color;
add policy pol type VPLMReference state one public all;
add person Dave;
add person Amy;
add person Bob;

This particular set of commands adds three users (Dave, Amy, and Bob) to the system. Additionally, this particular set of commands specifies a default attribute (e.g., a default color of “green”) for objects.

The next step in the illustrated flowchart is to create a module/branch 432. In some implementations, these steps may involve the system executing functionalities based on the following:

add module AxleAssembly branch Main;

This particular command adds a module, called “AxleAssembly,” and creates a branch, called “Main,” within that module.

An example of this is represented schematically in FIG. 5A, which shows a new module that includes a “Main” branch. The Main branch in the illustrated implementation has an initial iteration (labeled “0”) that is empty (i.e., it contains no content).

The next step in the illustrated flowchart 434 is where a user creates/sets a sandbox. In some implementations, these steps may involve the system executing functionalities based on the following:

set context user Amy;

add sandbox amySandbox1 module AxleAssembly branch Main;

This particular set of commands sets a first user, Amy, as a context user and adds a sandbox, called “amySandbox1,” which is linked to the module “AxleAssembly” module and the “Main” branch” of that module.

An example of this is represented schematically in FIG. 5B, which shows an association between Amy and the Main branch of the previously-created AxleAssembly module.

The next step in the illustrated flowchart 436 is where the first user, Amy, adds objects (e.g., business objects or relationships) to the module and commits the resulting content from her sandbox to the database (e.g., 326). In some implementations, these steps may involve the system executing functionalities based on the following:

```
add bus VPLMReference wheel1 0 policy pol vault unit1
  module AxleAssembly contentID
  10000000000000000000000000000001;
add bus VPLMReference wheel2 0 policy pol vault unit1
  module AxleAssembly contentID
  10000000000000000000000000000002;
commit sandbox;
add bus VPLMReference axle 0 policy pol vault unit1
  module AxleAssembly contentID
  10000000000000000000000000000003;
temp query bus * * * select attribute.value;
commit sandbox;
```

This particular set of commands first adds business object “wheel1” (represented by contentID 10000000000000000000000000000001) and “wheel2” (represented by contentID 10000000000000000000000000000002) to the “AxleAssembly” module. Then, an updated version of the design (that includes wheel1 and wheel2) created in Amy's sandbox, is committed to the database (e.g., 326). When the updated version of the design is committed, that updated version becomes a new iteration (and the system assigns that updated version a new iteration number/code). It is worth noting that while Amy was adding wheel1 and wheel2 in her sandbox, the contents of her sandbox were accessible only in Amy's sandbox. However, once the updated version of the design in the sandbox (that included wheel1 and wheel2) has been committed to the database, that updated version will be accessible to all of the system's authorized users—for viewing and/or editing—from their respective sandboxes. Next, the above set of commands adds business object “axle” (represented by contentID 10000000000000000000000000000003) to the “AxleAssembly” module. Then, an updated version of the design (that includes previously-added wheel1 and wheel2, and the newly added axle) created in Amy's sandbox, is committed to the database (e.g., 326). When the updated version of the design is committed, that updated version becomes a new iteration (and the system assigns that updated version a new iteration number/code). Once this further updated version of the design has been committed to the database, that further updated version will be accessible to all of the system's authorized users—for viewing and/or editing—from their respective sandboxes.

An example of this is represented schematically in FIG. 5C, which shows the initial iteration (labeled “0”) in the main branch of the Axle Assembly module, a first iteration (labeled “1”) that includes wheel1 and wheel2 in the main branch of the Axle Assembly module, and a second iteration (labeled “2”) that includes wheel1, wheel2, and an axle in the Main branch of the Axle Assembly module. At this point, since the color green was specified during setup as a default attribute, each of these subcomponents of the Axle Assembly in the module would be green.

The next step in the illustrated flowchart 438 is where a user (e.g., Amy) creates a new branch, called “Fix.” In some implementations, these steps may involve the system executing functionalities based on the following:

set context user creator;

branch module AxleAssembly from Main to Fix;

This particular set of commands indicates that the AxleAssembly module should include a branch from the Main branch to the Fix branch. In some implementations, unless otherwise specified, any branch is created from the latest iteration of its parent branch. For example, in this case, the Fix branch would be created from the latest iteration (iteration 2) of the Main branch. The newly created branch (e.g., the fix branch) is a virtual copy of the content that was current at the iteration of the parent branch. A physical object is not copied when there is a branch, only when it is changed. An example of this is represented schematically in FIG. 5D, which shows a new branch, called a Fix branch, having been added to the Main branch. The Fix branch extends from the latest iteration of the Main branch, which in the illustrated example is the second iteration (labeled “2”) on the Main branch. The Fix branch has an initial iteration (labeled “0”) that includes a virtual copy of the objects from its parent (i.e., the second iteration 2 of the Main branch).

The next step in the illustrated flowchart 440 is where Amy and a second user (e.g., Bob) updates objects in the Fix branch using their respective sandboxes. In some implementations, Amy's updates may involve the system executing functionalities based on the following:

set context user Amy;
add sandbox amySandbox2 module AxleAssembly branch Fix;
modbus C:10000000000000000000000000000001 color “red”;
print sandbox;

This particular set of commands set the content user to Amy, associates the Fix branch of the AxleAssembly module with Amy's sandbox (called “amysandbox2”), and modifies the color of the business object that corresponds to contentID 10000000000000000000000000000001 (i.e., wheel1) to red, and prints the sandbox. This set of commands does not commit that modification to the database 326. Therefore, the modification remains accessible only from Amy's sandbox (amysandbox2) and is not accessible or viewable to any other system users who are not using Amy's sandbox.

Meanwhile (also at 440), Bob's updates may involve the system executing functionalities based on the following:

```
set context user Bob;
add sandbox bobSandbox1 module AxleAssembly branch Fix;
del bus C:10000000000000000000000000000001;
modbus C:10000000000000000000000000000002 color “yellow”;
add bus VPLMReference OEMWheel1 0 policy pol vault unit1
  module AxleAssembly contentID
  10000000000000000000000000000004;
print sandbox;
    temp query bus * * * select attribute.value;
```

This particular set of commands sets Bob as a context user, associates the Fix branch of the AxleAssembly module to Bob's sandbox (called “bobSandbox1”). This particular set of commands further deletes the business object for wheel1 (represented by contentID 10000000000000000000000000000001), modifies the color of wheel2 (represented by contentID 10000000000000000000000000000002) from the default green to yellow, and adds an OEM wheel (OEMWheel1) (represented by contented 10000000000000000000000000000004). It also prints the content of Bob's sandbox. Notably, this set of commands does not commit Bob's modifications to the database 326. Therefore, Bob's modifications remain in Bob's sandbox (bobSandbox1) and are not accessible or viewable to any other system users who are not using Bob's sandbox.

An example of this is represented schematically in FIG. 5E, which shows Amy and Bob making (in their respective sandboxes only) different modifications to the design at iteration 0 of the Fix branch in the AxleAssembly module.

The next step in the illustrated flowchart 442 is where a third user (e.g., Dave) reviews the changes that Amy made and then Amy commits those changes to the database 326. In some implementations, this review and committal may involve the system executing functionalities based on the following:

set context user Dave;
set sandbox amySandbox2 as Amy;
print bus C:10000000000000000000000000000001
select attribute[color];
set context user Amy sandbox amySandbox2;
commit sandbox;

This particular set of commands first sets Dave as a context user, then sets the sandbox as amySandbox2. Dave reviews, including printing. Then, the context user is set to Amy in amySandbox2, and Amy's sandbox is committed to the database 326. At that point, the modifications Amy made become part of a new iteration (iteration 1) on the Fix branch of the AxleAssembly module.

An example of this is represented schematically in FIG. 5F, which shows Amy's modifications becoming part of a new iteration (iteration 1) on the Fix branch of the AxleAssembly module, and Bob's changes remaining in Bob's sandbox (and not becoming a new iteration).

The next step in the illustrated flowchart 444 involves synchronizing and resolving conflicts and committing Bob's changes. In some implementations, this step may involve the system executing functionalities based on the following:

set context user Bob;
set sandbox bobSandbox1;
commit sandbox; # error: not synced
sync sandbox;
temp query bus * * * select attribute.value;
commit sandbox; # error: conflict
print sandbox;
fix content 10000000000000000000000000000001 action
keep; # keep BO deletion
print sandbox;
temp query bus * * * select attribute.value;
commit sandbox;

This particular set of commands first sets Bob as a context user and sets the sandbox as bobSandbox1. Then, an attempt to commit Bob's sandbox is made. This, however, produces an error and an indication that the content in Bob's sandbox is not synchronized with the module. What follows is a synchronization process (which may include giving Bob the option to resolve any conflicts, one at a time, between the content in his sandbox and the latest iteration (iteration 1) of the fix branch. This is followed, in the example, by Bob committing his sandbox to database to create a new iteration (iteration 2) in the Fix branch of the AxleAssembly module.

An example of this is represented schematically in FIG. 5G, which shows content from Bob's sandbox being committed to produce iteration 2 in the Fix branch of the AxleAssembly module.

The next step in the illustrated flowchart 446 involves merging the Fix branch into the Main branch. In some implementations, this step may involve the system executing functionalities based on the following:

set context user Dave;
merge module AxleAssembly from Fix into Main;
set sandbox _merge_AxleAssembly_Main;
print sandbox;
commit sandbox;

This particular set of commands first sets Dave as a context user, then merges the Fix branch of the AxleAssembly module into the Main branch of the AxleAssembly module. Then, the sandbox is printed, and the sandbox is committed.

An example of this is represented schematically in FIG. 5H, which shows Dave merging the Fix branch of the AxleAssembly module into the Main branch of the AxleAssembly module. This creates a new iteration (iteration 3) in the Main branch of the AxleAssembly module.

The next step in the illustrated flowchart 448 involves querying content from different branches/iterations in the AxleAssembly module. This step can include any number of a variety of possible queries (or selections) using a selector. Some examples include:

set context user creator;
set system inivar set MX_BIT_PROFILE AxleAssembly/Main/1;
temp query bus * * * select name attribute[color];
set system inivar set MX_BIT_PROFILE AxleAssembly/Main/2;
temp query bus * * * select name attribute[color];
set system inivar set MX_BIT_PROFILE AxleAssembly/Main/3;
temp query bus * * * select name attribute[color];
set system inivar set MX_BIT_PROFILE AxleAssembly/Fix/1;
temp query bus * * * select name attribute[color];
set system inivar set MX_BIT_PROFILE AxleAssembly/Fix/2;
temp query bus * * * select name attribute[color];
print module AxleAssembly select *;
print module AxleAssembly select branch[Main].*;

In the foregoing context:
AxleAssembly/Main/1 refers to iteration 1 in the Main branch of the AxleAssembly module,
AxleAssembly/Main/2 refers to iteration 2 in the Main branch of the AxleAssembly module,
AxleAssembly/Main/3 refers to iteration 3 in the Main branch of the AxleAssembly module,
AxleAssembly/Fix/1 refers to iteration 1 in the Fix branch of the AxleAssembly module, and
AxleAssembly/Fix/2 refers to iteration 2 in the Fix branch of the AxleAssembly module.

Applications (e.g., 324 in FIG. 3) can leverage the foregoing module/branch/iteration techniques of modeling by incorporating various user-facing GUIs that will invoke the above commands to create and work with modules, branches and iterations.

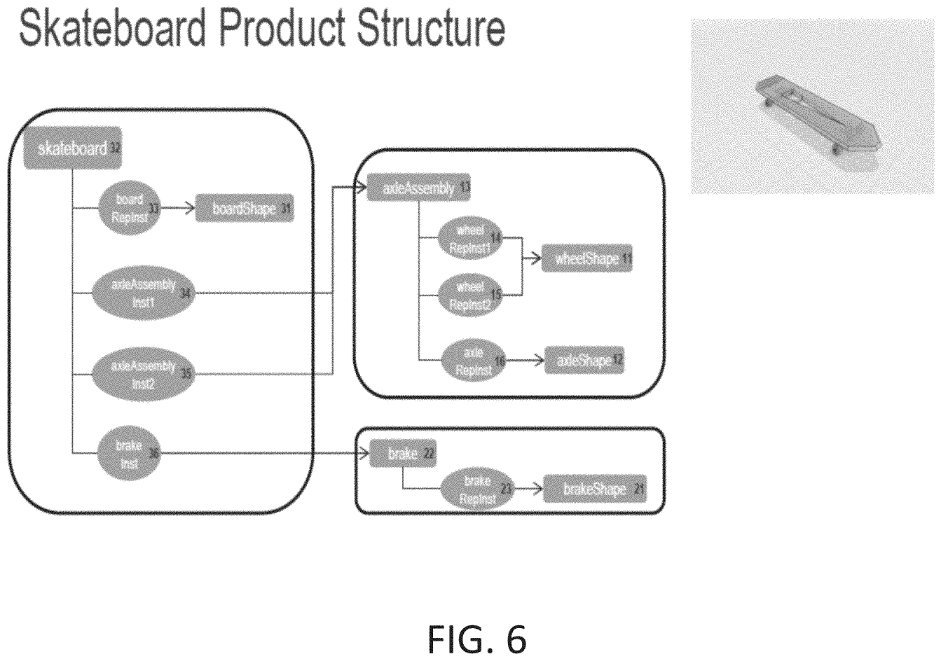

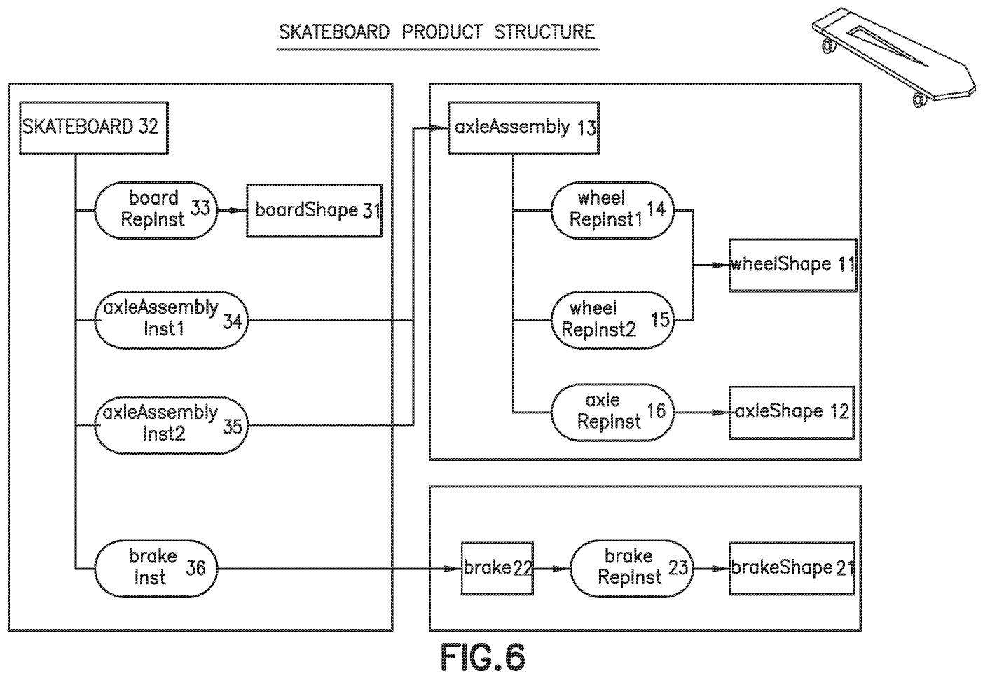

FIG. 6 is a schematic representation of an exemplary skateboard product structure that is managed (e.g., by the system disclosed herein) in three modules: SkateBoard, AxleAssembly, and Brake. The rectangles in the figure represent business objects and the ovals represent relationships connecting the objects. The labels represent the contentIDs for the objects (business objects and connections).

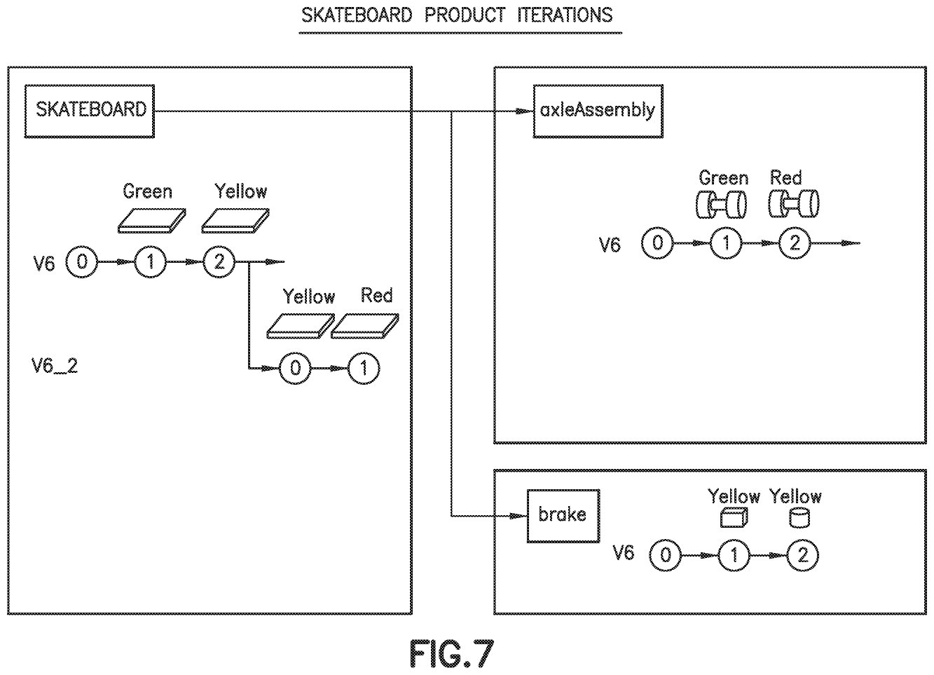

FIG. 7 is a schematic representation showing an evolution of the modules in FIG. 6 as content is added and modified.

As can be seen, the AxleAssembly and Brake have each gone through 2 iterations on a single branch, and the skateboard has gone through 2 iterations on branch V6, and a second branch V6_2 created that went through one more iteration on V6_2. Color and shapes are indicated to schematically represent some kind of change (e.g., size, shape, etc.) in module design from one iteration to the next. In general, the same contentID will map to different underlying physical objects (or relationships) as modules are branched and iterated. However, the physical objects underlying the contentIDs will not need to be copied/cloned unless they are actually changed. In real use cases, it is anticipated that these trees may grow to have hundreds of branches and thousands of iterations.

In an exemplary implementation, aspects of the module/branch/iteration systems and functionalities disclosed herein may be built within Dassault Systèmes Data Modeling Platform (e.g., on top of existing functionalities for defining data models) for specific purposes and managing the creation, modification, security and life-cycle aspects of objects and relationships so as to conform to the design intent of the data model designer. The data for the physical objects (and relationships) underlying these contentIDs, in such instances, may continue to be managed by this mature, robust modeling engine. In such implementations, the systems and techniques disclosed herein add, among other things, an ability to have these physical object evolve in a manner that supports easily and intuitively branching, iterating, parallel branches, and branch merging. In an exemplary implementation, this is implemented by the use of several new database tables that maintain some or all of the following kinds of information (e.g., in database 326):
mapping the Module/Branch/Iteration names to internal ids which can then be used to reference and form queries that will do the necessary/desired filtering,
tracking the creation of branches in each module (e.g., what Branch/Iteration the branch was created from, etc.),
tracking the merging of branches,
managing association between sandboxes and their associated module/branches,
tracking changed content in sandboxes so that conflict detection (and correction) can be done before the sandbox is committed,
associating contentIDs to the various underlying physical objects that they represent over time, as well as the necessary branch/iteration values that allow the contentIDs to continue to be associated to the same underlying objects over multiple iterations and or branches until the underlying object is actually modified.

These tables may be constructed so that they allow queries to be performed to help use contentIDs to find the underlying physical objects by filtering on branch/iteration within the SQL selects that are constructed.

A number of embodiments of the invention have been described. Nevertheless, it will be understood that various modifications may be made without departing from the spirit and scope of the invention.

For example, the systems and techniques disclosed herein are not limited to product design or lifecycle management. In various implementations, the systems and techniques may be applied in other contexts to enable multiple users to work simultaneously, or in parallel, on projects having multiple, interrelated aspects that require or benefit from tracking and management.

The systems and techniques disclosed herein can be implemented in a number of different ways. In one exemplary implementation, the systems and techniques disclosed herein may be incorporated into the modeling functionalities of the 3DExperience platform available from Dassault Systèmes, the applicant of the current application. In various implementations, the systems and techniques can be incorporated otherwise. The specific components, applications, etc. incorporated into a particular system may vary considerably.

Within the system, designs can be identified (in queries and otherwise) by profiles that amount to a sequence of module/branch/iteration specification. For example, different version of an overall skateboard design might be identified by any one of the following profiles: Profile 1 (board/v6/1, axleAssembly/V6/1, brake/V6/1), Profile 2 (board/v6/2, axleAssembly/V6/2, brake/V6/2), Profile 3 (board/v6_2/1, axleAssembly/V6/1, brake/V6/2), or Profile 4 (board/v6_2/1, axleAssembly/V6/2, brake/V6/2). The Profile 1 version of the skateboard in this example would include a board (iteration 1 of the V6 branch of the board module), an axle assembly (iteration 1 of the V6 branch of the axleAssembly branch), and a brake (iteration 1 of the V6 branch of the brake module). See, e.g., the skateboard product iteration view in FIG. 8. Typically, the module names (e.g., board, axleAssembly, and brake) would be user-specified. The branch names and iteration numbers/codes could be user-specified or assigned by the system automatically when a user commits a new version as a new iteration or branch. This is only one such convention for naming modules, branches, and iterations. Other conventions would be possible too.

Similarly, the Profile 2 version of the skateboard in this example would include iteration 1 of the V6 branch of the board module.

It should be understood that the example embodiments described herein may be implemented in many different ways. In some instances, the various methods and machines described herein may each be implemented by a physical, virtual, or hybrid general purpose computer, such as the computer system, or the computer network environment described herein. The computer system may be transformed into the machines that execute the methods described herein, for example, by loading software instructions into either memory or non-volatile storage for execution by the CPU. One of ordinary skill in the art should further understand that the system and its various components may be configured to carry out any embodiments or combination of embodiments of the present invention described herein. Further, the system may implement the various embodiments described herein utilizing any combination of hardware, software, and firmware modules operatively coupled, internally, or externally, to or incorporated into the system. Further, the system may be communicatively coupled to or be embedded within a manufacturing device and be configured so as to control the device to create a physical object as described herein.

Various aspects of the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to be solely a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Certain operations described in this specification (e.g., aspects of those represented in FIG. 4, and otherwise disclosed herein) can be implemented as operations performed by a data processing apparatus (e.g., a processor/specially-programmed processor) on data stored on one or more computer-readable storage devices or received from other sources, such as the computer system and/or network environment in FIGS. 1, 2, and/or 3. The term “processor” (or the like) encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be described herein as occurring in a particular order or manner, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Finally, in a typical implementation, the systems and techniques disclosed herein can be used to design (e.g., in an iterative fashion, with input from different team members) a product and/or one or more components of a product in a highly coordinated fashion. The resulting design typically is for a real-world physical object to be produced by a manufacturer. In some implementations, the manufacturer would use the resulting design, including any design details thereof for a corresponding one (e.g., the latest or simply desired) iteration of the design, alone or in combination with additional features, to produce/manufacture the real-world product or component(s) thereof through a series of real-world physical processes involving real-world materials, etc. The real-world product or component(s) thereof in this example would be or include a version of whatever was represented in the desired design iteration on a desired one of the branches The overall design and manufacturing process in this example would be significantly more efficient by relying on and utilizing an implementation of the systems and techniques disclosed herein than otherwise possible.

Other implementations are within the scope of the claims.

What is claimed is:

1. A computer-based method of managing iterations and branching in a design evolution, the method comprising:
creating a module that corresponds to a component in response to a user command; and
storing at least a first iteration and a second iteration of a design for the component in the module,
wherein each of the first and second iterations contains one or more content objects, and
wherein each content object is an entity or a relation, is identified by a content identifier, is part of a single unit of content that represents all evolutions of the entity or relation and is associated with a corresponding physical object.

2. The computer-based method of claim 1, wherein each of the first and second iterations, once stored, is immutable.

3. The computer-based method of claim 2, further comprising:
providing a mutable version of the first or second iteration to a first user's virtual workspace, in response to a request from the first user that specifies either the first or second iteration.

4. The computer-based method of claim 3, further comprising:
enabling the first user to modify any of the content objects in the mutable version, delete any of the content objects from the mutable version, and/or add new content objects to the mutable version, to create a modified version of the first or second iteration.

5. The computer-based method of claim 4, further comprising:
storing the modified version as a third iteration in the module, in response to the first user committing the modified version to the module,
wherein the third iteration, once stored, is immutable.

6. The computer-based method of claim 5, further comprising:
enabling all authorized users to access mutable versions of the immutable first iteration, the second iteration, and/or the third iteration in the module, from each respective users' virtual workspace.

7. The computer-based method of claim 3, further comprising:
storing the modified version as an initial iteration in a new branch within the module, in response to the first user committing the modified version to the module as the initial iteration in the new branch,
wherein the initial iteration in the new branch, once stored, is immutable.

8. The computer-based method of claim 7, further comprising:
storing the first iteration and the second iteration on an initial branch in the module,
wherein the new branch is different than the initial branch.

9. The computer-based method of claim 7, wherein the module is one of a plurality of modules and wherein each module contains one or more content objects organized into iterations and/or branches.

10. The computer-based method of claim 7, further comprising:
enabling the first user to merge branches within the modules from his or her virtual workspace.

11. The computer-based method of claim 7, further comprising:
enabling the first user to enter a query from a user interface device specifying one of the modules, one of the branches and one of the iterations; and
returning data to the user interface device that corresponds to the specified module, branch, and iteration in response to the query.

12. A computer-based system for managing iterations and branching in a design evolution, the computer-based system comprising:
one or more computer processing devices; and
computer-based memory operatively coupled to the one or more processing devices, wherein the computer-based memory stores computer-readable instructions that, when executed by the one or more processors, cause the computer-based system to:
create a module that corresponds to a component in response to a user command; and
store at least a first iteration and a second iteration of a design for the component in the module,
wherein each of the first and second iterations contains one or more content objects, and
wherein each content object is an entity or relation, is identified by a content identifier, is part of a single unit of content that represents all evolutions of the entity or relation and is associated with a corresponding physical object.

13. The computer-based system of claim 12, wherein each of the first and second iterations, once stored, is immutable.

14. The computer-based system of claim 13, wherein the computer-based memory stores further computer-readable instructions that, when executed by the one or more processors, cause the computer-based system to:
provide a mutable version of the first or second iteration to a first user's virtual workspace, in response to a request from the first user that specifies either the first or second iteration; and
enable the first user to modify the content objects in the mutable version, delete the content objects from the mutable version, and/or add new content objects to the mutable version, to create a modified version of the first or second iteration.

15. The computer-based system of claim 14, wherein the computer-based memory stores further computer-readable instructions that, when executed by the one or more processors, cause the computer-based system to save the modified version as a third iteration in the module, in response to the first user committing the modified version to the module, wherein the third iteration, once stored, is immutable.

16. The computer-based system of claim 15, wherein the computer-based memory stores further computer-readable instructions that, when executed by the one or more processors, cause the computer-based system to:
enable all authorized users to access mutable versions of the immutable first iteration, the second iteration, and/or the third iteration in the module, from each respective users' virtual workspace.

17. The computer-based system of claim 14, wherein the computer-based memory stores further computer-readable instructions that, when executed by the one or more processors, cause the computer-based system to:
store the modified version as an initial iteration in a new branch within the module, in response to the first user committing the modified version to the module as the initial iteration in the new branch, wherein the initial iteration in the new branch, once stored, is immutable; and
store the first iteration and the second iteration on an initial branch in the module,
wherein the new branch is different than the initial branch.

18. The computer-based system of claim 12, wherein the module is one of a plurality of modules and wherein each module contains one or more content objects organized into iterations and/or branches.

19. The computer-based system of claim 18, wherein the computer-based memory stores further computer-readable instructions that, when executed by the one or more processors, cause the computer-based system to:
enable the first user to merge branches within the modules from his or her virtual workspace.

20. The computer-based system of claim 12, wherein the computer-based memory stores further computer-readable instructions that, when executed by the one or more processors, cause the computer-based system to:
enable the first user to enter a query from a user interface device specifying one of the modules, one of the branches and one of the iterations; and
return data to the user interface device that corresponds to the specified module, branch, and iteration in response to the query.

21. A non-transitory computer readable medium having stored thereon computer-readable instructions that, when executed by a computer-based processor, causes the computer-based processor to:
create a module that corresponds to a component in response to a user command; and
store at least a first iteration and a second iteration of a design for the component in the module,
wherein each of the first and second iterations contains one or more content objects, and
wherein each content object is an entity or a relation, is identified by a content identifier, is part of a single unit of content that represents all evolutions of the entity or relation and is associated with a corresponding physical object.

22. An object-orientated data model comprising:
a user-specified module containing content objects, wherein each content object is either an entity or a relation, wherein each content object has a content ID and an associated physical object, and wherein the content objects are organized into branches and iterations within the module, wherein an iteration is a change to one or more contained content objects, and wherein an associated one of the content IDs for one of the changed content objects refers to a different physical object after the change.
